(19) United States
(12) Patent Application Publication
(10) Pub. No.: US 2004/0097260 A1
(43) Pub. Date: May 20, 2004

(54) Communication infrastructure

(76) Inventors: Stuart Philip Stenton, N wport/Berkeley (GB); Matthew Murray Williamson, Bishopston (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/629,849

(22) Filed: Jul. 30, 2003

(30) Foreign Application Priority Data
Jul. 31, 2002 (GB) 0217869.7

(51) Int. Cl. H04Q 7/24

(52) U.S. Cl. 455/552.1; 455/426.1; 370/338

(57) ABSTRACT

A communication infrastructure comprising: a cellular telecommunications network having a distribution of cell sites defining a cellular coverage of the network; a matrix of wireless local area networks (WLANs) each of which is connected to the cellular telecommunications network over a private data network, at least some of the WLANs in the matrix falling within the cellular coverage of the cellular telecommunications network; and a plurality of mobile communication devices having both cellular communications network and wireless LAN connectivity, wherein the WLANs making up the matrix are selectively activated upon a request from the cellular telecommunications network in dependence on a determination when a mobile communication device connected to the cellular telecommunication network may be able to access one or more specified wireless LANs.

This invention relates to a communication infrastructure and more particularly to the integration of a low bandwidth cellular telecommunications network with a high bandwidth wireless local area network.

Conventional cellular telecommunications networks have a distribution of cell sites which define a cellular coverage for the network. Typically, the size of a cell can be from 1 to 20 miles in diameter depending upon terrain and transmission power. Cellular telecommunication networks offer a low bandwidth communication channel with data rates up to 114 kbps for general packet radio services (GPRS) packet-based services. The main advantage of cellular telecommunications network is the wide ranging cellular coverage available.

Wireless local area networks (LANs) operating to the IEEE 802.11 standards are now commonly available but suffer from a restricted range in the region of 150 feet whilst offering data rates of up to 1 Mbps (802.11b) and 54 Mbps (802.11a).

Accordingly, one aspect of the present invention provides a communication infrastructure comprising: a cellular telecommunications network having a distribution of cell sites defining a cellular coverage of the network; a matrix of wireless local area networks (WLANs) each of which is connected to the cellular telecommunications network over a private data network, at least some of the WLANs in the matrix falling within the cellular coverage of the cellular telecommunications network; and a plurality of mobile communication devices having both cellular communications network and wireless LAN connectivity, wherein the WLANs making up the matrix are selectively activated upon a request from the cellular telecommunications network in dependence on a determination when a mobile communication device connected to the cellular telecommunication network may be able to access one or more specified wireless LANs.

Advantageously, the determination of whether the mobile communication device may be able to access the one or more specified wireless LANs is made in dependence on the location of a mobile communication device in a cell.

Conveniently, the determination utilises location identifying features of the cellular telecommunication network.

Another aspect of the present invention provides a communication infrastructure comprising: a cellular telecommunications network having a distribution of cell sites defining a cellular coverage of the network; a matrix of wireless local area networks (WLANs) each of which is connected to the cellular telecommunications network over a private data network, at least some of the WLANs in the matrix falling within the cellular coverage of the cellular telecommunications network; and a plurality of mobile communication devices having both cellular communications network and wireless LAN connectivity, wherein the WLANs making up the matrix are selectively activated upon a request from the cellular telecommunications network in dependence on a determination when a mobile communication device connected to the cellular telecommunication network may be able to access one or more specified wireless LANs, the determination of whether the mobile communication device may be able to access the one or more specified wireless LANs being made in dependence on the location of a mobile communication device in a cell.

A further aspect of the present invention provides a communication infrastructure comprising: a cellular telecommunications network having a distribution of cell sites defining a cellular coverage of the network; a matrix of wireless local area networks (WLANs) each of which is connected to the cellular telecommunications network over a private data network, at least some of the WLANs in the matrix falling within the cellular coverage of the cellular telecommunications network; and a plurality of mobile communication devices having both cellular communications network and wireless LAN connectivity, wherein the WLANs making up the matrix are selectively activated upon a request from the cellular telecommunications network in dependence on a determination when a mobile communication device connected to the cellular telecommunication network may be able to access one or more specified wireless LANs, wherein the determination utilises location identifying features of the cellular telecommunication network.

Another aspect of the present invention provides a communication infrastructure comprising: a cellular telecommunications network having a distribution of cell sites defining a cellular coverage of the network; a matrix of wireless local area networks (WLANs) each of which is connected to the cellular telecommunications network over a private data network, at least some of the WLANs in the matrix falling within the cellular coverage of the cellular telecommunications network; and a plurality of mobile communication devices having both cellular communications network and wireless LAN connectivity, wherein the WLANs making up the matrix are selectively activated upon a request from the cellular telecommunications network in dependence on a determination when a mobile communication device connected to the cellular telecommunication network may be able to access one or more specified wireless LANs, the determination of whether the mobile communication device may be able to access the one or more specified wireless LANs being made in dependence on the location of a mobile communication device in a cell, wherein the determination utilises location identifying features of the cellular telecommunication network.

A further aspect of the present invention provides a method of integrating a low bandwidth cellular telecommunications network with a high bandwidth wireless LAN comprising the steps of: providing a mobile communication device with cellular telecommunication network connectivity and WLAN connectivity, the cellular telecommunication network authorsing connection of the mobile communication device to a wireless LAN over a private data network, the wireless LAN being selectively activated upon a request from the cellular telecommunications network in dependence on a determination when a mobile communication device connected to the cellular telecommunication network may be able to access one or more specified wireless LANs; and connecting the mobile communication device to the wireless LAN.

Another aspect of the present invention provides a method of integrating a low bandwidth cellular telecommunications network with a high bandwidth wireless LAN comprising the steps of: providing a mobile communication device with cellular telecommunication network connectivity and WLAN connectivity; the cellular telecommunication network authorising connection of the mobile communication device to a wireless LAN over a private data network, the wireless LAN being selectively activated upon a request from the cellular telecommunications network in dependence on a determination when a mobile communication device connected to the cellular telecommunication network may be able to access one or more specified wireless LANs; and connecting the mobile communication device to the wireless LAN.

A further aspect of the present invention provides a mobile communication device incorporating a wireless LAN chip set and a cellular telecommunication modem set to enable cellular telecommunication network connectivity and wireless LAN connectivity, the device further having a processor programmed to receive authorisation to use one or more specified wireless LANs from a cellular telecommunication network provider over the cellular telecommunication modern and to use the wireless LAN chip set to access the one or more specified wireless LANs upon a determination that the mobile communication device may be able to access the one or more specified wireless LANs.

Another aspect of the present invention provides a cellular telecommunication network adapted to: determine when a mobile communication device connected to the cellular telecommunication network may be able to access one or more specified wireless LANs; obtain authorisation for the mobile communication device to use the one or more specified wireless LANs; and provide to the mobile communication device information enabling the mobile communication device to use the one or more specified wireless LANs.

In order that the present invention may be more readily understood, embodiments thereof will now be described, by way of example, with reference to the accompanying drawing, in which the Figure is a schematic representation of a communication infrastructure embodying the present invention.

Referring to the Figure, the communication infrastructure 1 embodying the present invention comprises a marriage between a cellular telecommunications network 2 and a matrix of wireless local area networks 3. In the cellular telecommunication network 2, a Mobile Telephone Switching Office (MTSO) 4 is connected to a plurality of cell sites 5, each of which defines a cell 6—the so called cellular coverage for that cell Site 5. The cells 6 are shown schematically in the Figure as circles of fixed diameter although the size and shape of each cell 6 will vary in dependence upon terrain and transmitter power. Typically, the cells 6 in the cellular telecommunication network 2 will overlap one another. In operation, a plurality of mobile communication devices 7, falling within a cell 6 are able to communicate via the associated cell site 5 to other mobile communication devices 7 or to a public switched telephone network (PSTN) 8, connected to the Mobile Telephone Switching Office 4.

The growing proliferation of wireless local area networks 3 especially within urban environments, airports, train stations and the like, means that there is growing coverage allowing connection of mobile communication devices to wireless LANs 3. Preferably, the wireless LANs are IEEE 802.11a, 802.11b or 802.11e wireless LANs.

The wireless LANs 3 may be entirely independent of one another or be owned by businesses or individuals within a location and may be primarily intended for use of those businesses or individuals. However, the wireless LANs 3 may each be connected over a private data network 9 (virtual private network) to the Internet 10 for connection to services but also for administration and billing purposes to a wireless Internet service provider 11.

In this embodiment of the present invention, the wireless Internet service provider 11 may own, or control access to, or be able to authorise access by third parties to the wireless LANs 3 meeting the wireless Internet service provider's quality of service and security criteria. The wireless LANs 3 therefore make up a matrix of wireless LANs 3 offering considerable coverage. The controlling function of the wireless Internet service provider allows mobile communication devices 7 equipped with wireless LAN cards or chip sets 12 to communicate with wireless LANs 3 and via the private data network 9 provided by the wireless LAN 3 to communicate with remote servers or other service providers accessible over the Internet or the like.

The controlling function of the wireless Internet service provider 11 also allows wireless LAN roaming between neighbouring or overlapping wireless LAN coverage areas 13 allowing a mobile communication device 7 to be handed over from one wireless LAN 3 to another wireless LAN 3 in the same matrix i.e. a group of local wireless LANs under the control of, or registered with, the wireless Internet service provider.

Referring to the Figure, this shows a route of a user having a mobile communication device 7 passing through a matrix of wireless LANs, the emboldened circles representing cells which have been activated within the matrix and the other cells not being activated since they are not along the route of the mobile communication device 7.

Since the wireless LANs 3 need not necessarily be owned by the wireless Internet service provider 11, the wireless LAN 3 owners would register with the wireless Internet service provider 11 who would impose quality and integrity constraints and compensate the owner of the wireless LANs 3 for the third party or public usage of their wireless LANs 3, such use being logged by the wireless Internet service provider 11 and transmitted to the cellular telecommunications network 2 operator.

The wireless LANs 3 may also provide site-specific services to the mobile communication devices 7 including advertising, possibly in lieu of recompense by the wireless Internet service provider 11.

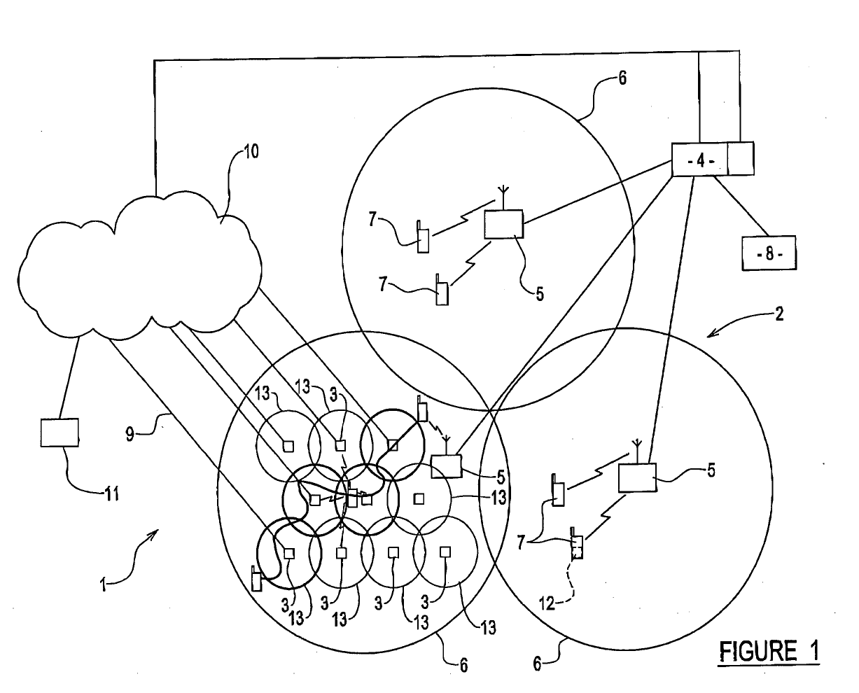

The mobile communication devices 7 populating the above-mentioned telecommunications infrastructure embodying the present invention incorporate both cellular telecommunication connectivity (modem cards 13) and wireless LAN connectivity (wireless LAN chip sets 12) and are thus able to benefit from the low bandwidth services provided by the cellular telecommunication network 2 as well as the high bandwidth services which can be provided by the matrix of wireless local area networks 3. However, because of the limited range of wireless LANs 3 and the need for users normally to keep their mobile communication devices 7 switched on so as to receive urgent calls or information, the normally battery-operated mobile communication devices 7 cannot sustain long periods of constant use transmitting and receiving information on a high bandwidth communication channel. Accordingly, “always on” wireless LAN reception is not always desirable on such small, battery operated devices. Thus, the mobile communication devices 7 embodying the present invention, whilst allowing connectivity to both the cellular telecommunications network 2 and wireless LANs 3 are normally left “always on” in only the cellular telecommunication network mode which requires less power than the wireless LAN mode. When a user of a mobile communication device requires access to a high bandwidth connection, then the user can request this through the cellular telecommunications network. In the example shown in FIG. 1, either a cell site 5 within which the mobile user is located or the MTSO 4 would request of the wireless Internet service provider 11 that wireless local area networks 3 in the vicinity of the user are activated and made available to the mobile communication device 7. Upon actuation by the service provider of a wireless LAN 3 within range of the mobile communication device 7, the: user can then partake of the high bandwidth service requested through the wireless LANs 3 as required.

The wireless Internet service provider 11 automatically renumerates the owner of the wireless LAN 3 used to provide the high bandwidth service to the mobile user and the user would be billed centrally either directly by the wireless Internet service provider 11 or, if the wireless Internet service provider is integrated with or associated with the Mobile Telephone Switching Office 4, then the billing can be done centrally through the cellular telecommunication network providers facilities.

The wireless LAN roaming facility allows wireless LANs 3 to be selectively activated so that not all wireless LANs within the matrix of wireless LANs are activated but only those within range of the mobile communication device 7 requesting the high bandwidth service. This ability can be tied in with the location identifying features of a cellular telecommunication network 2 to determine the location of the mobile communication device within a cell and to activate only those cells in immediate proximity or within range of selected wireless LANs 3 so as to minimise the number of wireless LANs 3 that must be activated to provide the requested high bandwidth service to the mobile communication device 7.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. A communication infrastructure comprising:
a cellular telecommunications network having a distribution of cell sites defining a cellular coverage of the network;
a matrix of wireless local area networks (WLANs) each of which is connected to the cellular telecommunications network over a private data network, at least some of the WLANs in the matrix falling within the cellular coverage of the cellular telecommunications network, and
a plurality of mobile communication devices having both cellular communications network and wireless LAN connectivity, wherein the WLANs making up the matrix are selectively activated upon a request from the cellular telecommunications network in dependence on a determination when a mobile communication device connected to the cellular telecommunication network may be able to access one or more specified wireless LANs.

2. An infrastructure according to claim 1, wherein the matrix of wireless LANS are registered with a wireless Internet service provider.

3. An infrastructure according to claim 1, wherein the private data network is a virtual private network.

4. An infrastructure according to claim 1, wherein wireless roaming between WLANs in the matrix is enabled

5. An infrastructure according to claim 1, wherein only WLANs within range of a mobile communication device are activated upon the request from the cellular telecommunication network.

6. An infrastructure according to claim 1, wherein the wireless LANs in the matrix are selected from the group consisting of: 802.11a, 802.11b and 802.11e.

7. An infrastructure according to claim 1, wherein the wireless Internet service provider comprises the cellular telecommunications network provider.

8. An infrastructure according to claim 1, wherein the mobile communications device is a battery operated normally-on device.

9. An infrastructure according to claim 1, wherein the cellular telecommunications network provides low bandwidth services to the mobile communication devices and the matrix of WLANs provides high bandwidth services to the mobile communication devices.

10. An infrastructure according to claim 1, wherein the cell sites are connected to a mobile telephone switching office (MTSO) connected to a public switched telephone network (PSTN).

11. An infrastructure according to claim 1, wherein the determination of whether the mobile communication device may be able to access the one or more specified wireless LANs is made in dependence on the location of a mobile communication device in a cell.

12. An infrastructure according to claim 11, wherein the determination utilises location identifying features of the cellular telecommunication network.

13. A communication infrastructure comprising:
a cellular telecommunications network having a distribution of cell sites defining a cellular coverage of the network;
a matrix of wireless local area networks (WLANs) each of which is connected to the cellular telecommunications network over a private data network, at least some of the WLANs in the matrix falling within the cellular coverage of the cellular telecommunications network; and
a plurality of mobile communication devices having both cellular communications network and wireless LAN connectivity, wherein the WLANs making up the matrix are selectively activated upon a request from the cellular telecommunications network in dependence on a determination when a mobile communication device connected to the cellular telecommunication network may be able to access one or more specified wireless LANs, the determination of whether the mobile communication device may be able to access the one or more specified wireless LANs being made in dependence on the location of a mobile communication device in a cell.

14. A communication infrastructure comprising:
a cellular telecommunications network having a distribution of cell sites defining a cellular coverage of the network;
a matrix of wireless local area networks (WLANs) each of which is connected to the cellular telecommunications network over a private data network, at least some of the WLANs in the matrix falling within the cellular coverage of the cellular telecommunications network; and
a plurality of mobile communication devices having both cellular communications network and wireless LAN connectivity, wherein the WLANs making up the matrix are selectively activated upon a request from the cellular telecommunications network in dependence on a determination when a mobile communication device connected to the cellular telecommunication network may be able to access one or more specified wireless LANs, wherein the determination utilises location identifying features of the cellular telecommunication network.

15. A communication infrastructure comprising:
a cellular telecommunications network having a distribution of cell sites defining a cellular coverage of the network;
a matrix of wireless local area networks (WLANs) each of which is connected to the cellular telecommunications network over a private data network, at least some of the WLANs in the matrix falling within the cellular coverage of the cellular telecommunications network; and
a plurality of mobile communication devices having both cellular communications network and wireless LAN connectivity, wherein the WLANs making up the matrix are selectively activated upon a request from the cellular telecommunications network in dependence on a determination when a mobile communication device connected to the cellular telecommunication network may be able to access one or more specified wireless LANs, the determination of whether the mobile communication device may be able to access the one or more specified wireless LANs being made in dependence on the location of a mobile communication device in a cell, wherein the determination utilises location identifying features of the cellular telecommunication network

16. A method of integrating a low bandwidth cellular telecommunications network with a high bandwidth wireless LAN comprising the steps of:
providing a mobile communication device with cellular telecommunication network connectivity and WLAN connectivity,
the cellular telecommunication network authorising connection of the mobile communication device to a wireless LAN over a private data network the wireless LAN being selectively activated upon a request from the cellular telecommunications network in dependence on a determination when a mobile communication device connected to the cellular telecommunication network may be able to access one or more specified wireless LANs; and
connecting the mobile communication device to the wireless LAN.

17. A method according to claim 16 comprising the step of determining whether the mobile communication device may be able to access the one or more specified wireless LANs in dependence on the location of a mobile communication device in a cell.

18. A method according to claim 17, wherein the determining step utilises location identifying features of the cellular telecommunication network.

19. A method of integrating a low bandwidth cellular telecommunications network with a high bandwidth wireless LAN comprising the steps of:
providing a mobile communication device with cellular telecommunication network connectivity and WLAN connectivity,
the cellular telecommunication network authorsing connection of the mobile communication device to a wireless LAN over a private data network, the wireless LAN being selectively activated upon a request from the cellular telecommunications network in dependence on a determination when a mobile communication device connected to the cellular telecommunication network may be able to access one or more specified wireless LANs; and
connecting the mobile communication device to the wireless LAN.

20. A method according to claim 19 comprising the step of determining whether the mobile communication device may be able to access the one or more specified wireless LANs in dependence on the location of a mobile communication device in a cell.

21. A method according to claim 20, wherein the determining step utilises location identifying features of the cellular telecommunication network

22. A mobile communication device incorporating a wireless LAN chip set and a cellular telecommunication modem set to enable cellular telecommunication network connectivity and wireless LAN connectivity, the device further having a processor programmed to receive authorisation to use one or more specified wireless LANs from a cellular telecommunication network provider over the cellular telecommunication modem and to use the wireless LAN chip set to access the one or more specified wireless LANs upon a determination that the mobile communication device may be able to access the one or more specified wireless LANs.

23. A mobile communication device according to claim 22, wherein the determination of whether the mobile communication device may be able to access the one or more specified wireless LANs is made in dependence on the location of a mobile communication device in a cell.

24. A mobile communication device according to claim 23, wherein the determination utilises location identifying features of the cellular telecommunication network.

25. A cellular telecommunication network adapted to:
determine when a mobile communication device connected to the cellular telecommunication network may be able to access one or more specified wireless LANs;
obtain authorisation for the mobile communication device to use the one or more specified wireless LANs; and
provide to the mobile communication device information enabling the mobile communication device to use the one or more specified wireless LANs.

26. A cellular telecommunications network according to claim 25 further adapted to activate the one or more specified wireless LANs.

27. A cellular telecommunications network according to claim 25, wherein a determination of whether the mobile communication device may be able to access the one or more specified wireless LANs is made in dependence on the location of a mobile communication device in a cell.

28. A cellular telecommunications network according to claim 27, wherein the cellular telecommunication network has location identifying features to determine the location of the mobile communication device within a cell and the determination utilises the location identifying features of the cellular telecommunication network.
